(19) United States
(12) Patent Application Publication
(10) Pub. No.: US 2007/0035906 A1
(43) Pub. Date: Feb. 15, 2007

(54) Transient blocking unit

(76) Inventors: Richard A. Harris, Palo Alto, CA (US); Richard A. Blanchard, Los Altos, CA (US); Francois Hebert, San Mateo, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/503,357

(22) Filed: Aug. 10, 2006

Related U.S. Application Data
(60) Provisional application No. 60/707,602, filed on Aug. 11, 2005.

(51) Int. Cl. H02H 9/06

(52) U.S. Cl. 361/118

(57) ABSTRACT

Improved electrical transient blocking is provided with a transient blocking unit (TBU) having a partial disconnect capability. A TBU is an arrangement of voltage controlled switches that normally conducts, but switches to a disconnected state in response to an above-threshold input transient. Partial disconnection improves the power handling capability of a TBU by preventing thermal damage to the TBU. Partial TBU disconnection can be implemented to keep power dissipation in the TBU below a predetermined level Pₘₐₓ, thereby avoiding thermal damage to the TBU by keeping the TBU temperature below a temperature limit Tₘₐₓ. Alternatively, partial TBU disconnection can be implemented to keep TBU temperature below Tₘₐₓ using direct temperature sensing and feedback.

### CROSS REFERENCE TO RELATED APPLICATIONS

This application claims the benefit of U.S. provisional application 60/707,602, filed on Aug. 11, 2005, entitled “Improved Transient Blocking Unit”, and hereby incorporated by reference in its entirety.

### FIELD OF THE INVENTION

This invention relates to use of a transient blocking unit (TBU) to protect an electrical load from over-voltage and/or over-current conditions.

### BACKGROUND

Many circuits, networks, electrical devices and data handling systems are operated in configurations and environments where external factors can impair their performance, cause failure or even result in permanent damage. Among the most common of these factors are over-voltage and over-current. Protection against these factors is important and has been addressed in the prior art in various ways.

Fuses that employ thermal or magnetic elements are one common protection measure. In other cases, protection circuits are available. Some examples are described in U.S. Pat. Nos. 5,130,262; 5,625,519; 6,157,529; 6,828,842 and 6,898,060. Protection circuits are further specialized depending on conditions and application. For example, in the case of protecting batteries or rechargeable elements from overcharging and over-discharging one can refer to circuit solutions described in U.S. Pat. Nos. 5,789,900; 6,313,610; 6,331,763; 6,518,731; 6,914,416; 6,948,078; 6,958,591 and U.S. Published Application 2001/00210192. Still other protection circuits, e.g., ones associated with power converters for IC circuits and devices that need to control device parameters and electric parameters simultaneously also use these elements. Examples can be found in U.S. Pat. Nos. 5,929,665; 6,768,623; 6,855,988; 6,861,828.

When providing protection for very sensitive circuits, such as those encountered in telecommunications the performance parameters of the fuses and protection circuits are frequently insufficient. A prior art solution embodied by transient blocking units (TBUs) that satisfy a number of the constraints is considered in international publications PCT/AU94/00358; PCT/AU04/00117; PCT/AU03/00175; PCT/AU03/00848 as well as in U.S. Pat. Nos. 4,533,970; 5,742,463 and related literature cited in these references.

In a TBU, two or more transistors are arranged such that they normally provide a low series resistance. However, when an over-voltage or over-current transient is applied to the TBU, the transistors switch to a high impedance current blocking state, thereby protecting a load connected in series to the TBU. Variations and/or refinements of the basic TBU concept are considered in U.S. Pat. Nos. 3,916,220, 5,319,515, 5,625,519, 5,696,659, 5,729,418, 6,002,566, 6,118,641, 6,714,393, 6,865,063, and 6,970,337.

A conventional TBU provides combined current limiting and current disconnect performance, as shown on FIG. 1. A TBU having zero applied voltage is in a low impedance state, where the current through the TBU rises rapidly as the voltage across the TBU increases. The current through the TBU is limited to be no greater than a trigger current It, so once this current level is reached, the TBU current does not change as the TBU voltage further increases. When the TBU voltage exceeds a disconnect voltage V_{d}, the TBU switches to a high impedance state, effectively isolating downstream electrical devices and circuits from the transient. Accordingly, conventional TBUs are designed to withstand a maximum power dissipation Pₘₐₓ that is at least IₜV_{d}.

This constraint on TBU power dissipation can cause problems in practice. For example, powered span telecommunication systems typically have operating voltages of 50 to 110 VDC (the voltage can be as high as 180 VDC), in combination with currents much less than 200 mA. Protecting such a system with a 200 mA TBU would be desirable, but difficulties can occur when power is applied to the span (e.g., at start up) or when a TBU is inserted following a “break then make” protocol. To accommodate the line-charging transient by limiting the current to 200 mA without disconnecting, a conventional TBU would require a power handling capacity of at least 20-40 W (since V_{d} would need to be on the order of 110 to 180 V). Providing such high power handling capacity is costly, and it is also highly inefficient, since TBU power dissipation in normal line operation is far less than 20-40 W in this example.

One approach for alleviating this problem is to provide a low power TBU (e.g., having V_{d} on the order of 5 V for a 1 W, 200 mA TBU), and to protect this TBU from normal transients associated with powering up the span. However, protecting the TBU from normal span transients undesirably adds complexity to the system. Accordingly, it would be an advance in the art to provide a TBU that more efficiently accommodates normal span transients without going into a full disconnect mode.

### SUMMARY

As indicated above, a conventional TBU limits the current to a trigger current Iₜ, and disconnects when the voltage exceeds the disconnect voltage V_{d}. In contrast, TBUs according to the present invention have a disconnect condition that is related to the TBU temperature (e.g., a TBU die temperature).

In a first embodiment of the invention, a maximum TBU power Pₘₐₓ is derived from a maximum TBU temperature Tₘₐₓ, such that if the TBU power dissipation does not exceed Pₘₐₓ, then the TBU temperature does not exceed Tₘₐₓ, and that thermal damage to the TBU will not occur for TBU temperatures less than Tₘₐₓ. Thus the temperature can be held to values less than Tₘₐₓ by requiring the power dissipation to be less than Pₘₐₓ. In operation, the impedance of the TBU increases in response to increasing applied voltage such that the TBU power does not exceed Pₘₐₓ. For example, FIG. 2 shows typical behavior for such a TBU, where the TBU partially disconnects (i.e., the TBU impedance increases, but not to its maximum level) as voltage increases in such a way as to approximately follow a curve of constant TBU power dissipation.

In a second embodiment of the invention, a temperature sensor responsive to the TBU temperature is included in the TBU. In operation of this TBU, the TBU impedance increases in response to increasing applied voltage such that the sensed TBU temperature does not exceed a maximum TBU temperature Tₘₐₓ. For example, FIG. 3 shows typical behavior for such a TBU, where the TBU partially disconnects as voltage increases in such a way as to approximately follow a curve of constant TBU temperature.

An advantage of this second embodiment is that direct temperature monitoring automatically accounts for possible TBU heat sink variability (either from device to device, or over time). In contrast, Pₘₐₓ for TBUs of the first embodiment will depend on the level of heat sinking provided to the TBU (e.g., improving the heat sinking of a TBU will increase Pₘₐₓ for a fixed Tₘₐₓ). Thus, in the first embodiment, Pₘₐₓ is determined by Tₘₐₓ and by the TBU heat sinking performance. For example, if a simple thermal resistance model is applicable, then Pₘₐₓ is on the order of Rₜₕ(Tₘₐₓ-T₀), where Rₜₕ is the thermal resistance provided to the TBU by the heat sink and T₀ is room temperature.

### BRIEF DESCRIPTION OF THE DRAWINGS

FIG. 1 shows a relation between Iₜ, V_{d} and Pₘₐₓ for a TBU.

FIG. 2 shows partial disconnection of a TBU according to a first embodiment of the invention.

FIG. 3 shows partial disconnection of a TBU according to a second embodiment of the invention.

FIG. 4 is a schematic diagram of a conventional unipolar TBU.

FIG. 5 is a schematic diagram of a first example of the invention.

FIG. 6 is a schematic diagram of a second example of the invention.

FIG. 7 is a schematic diagram of a third example of the invention.

FIG. 8 is a schematic diagram of a fourth example of the invention.

FIG. 9 is a schematic diagram of a fifth example of the invention.

FIG. 10 is a schematic diagram of a sixth example of the invention.

FIG. 11 is a schematic diagram of a seventh example of the invention.

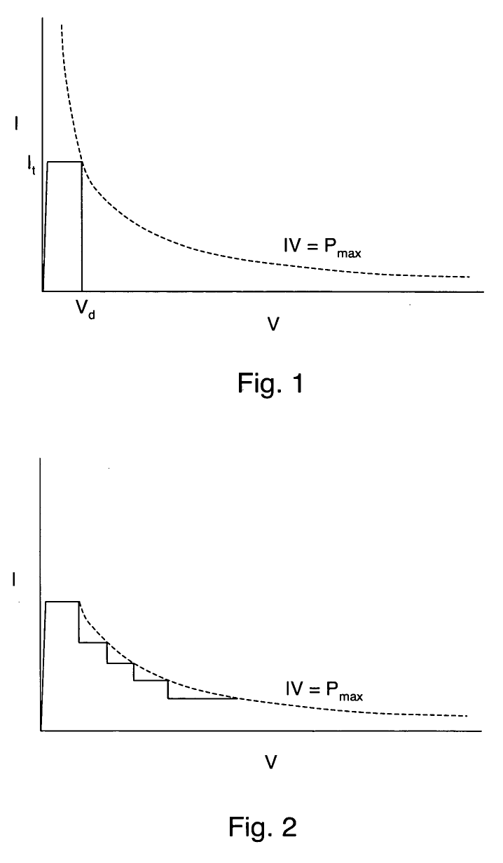

### DETAILED DESCRIPTION

Conventional TBU operation is best appreciated by beginning with the unipolar example of FIG. 4. The circuit of FIG. 4 has a depletion mode n-channel NMOS transistor 402 (Q1) and a depletion mode p-channel JFET 404 (Q2). The source of Q1 is connected to the source of Q2, the gate of Q1 is connected to the drain of Q2, and the drain of Q1 is connected to the gate of Q2. The TBU input is the drain of Q1 and the TBU output is the drain of Q2. As I_{TBU} flows through Q1 and Q2, corresponding source-drain voltage drops V1 and V2 are generated. The gate to source voltage for Q2 is V1 and the gate to source voltage for Q1 is V2. As the gate to source voltages for Q1 and Q2 increase, V1 and V2 also tend to increase (since Q1 and Q2 are depletion mode devices), and this self-reinforcing feedback drives the TBU to a high impedance state when V_{TBU} exceeds the disconnect voltage V_{d}, thereby disconnecting the TBU. Once disconnected, a small leakage current (which is typically negligible) continues to flow through the TBU.

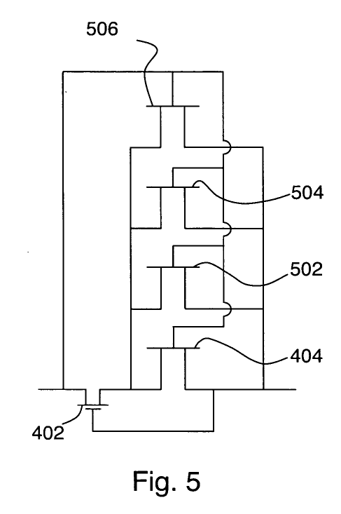

FIG. 5 shows a first example of the invention. Additional depletion mode p-channel JFETs 502 (Q2), 504 (Q3), and 506 (Q4) are connected in parallel with JFET 404 (Q1). In this circuit, each of the p-channel JFETs Q1-Q4 has a different pinch-off voltage (Vₚ) and a different series resistance Rₒₙ. More specifically, Vₚ₁<Vₚ₂<Vₚ₃<Vₚ₄ and Rₒₙ₁<Rₒₙ₂<Rₒₙ₃<Rₒₙ₄. Furthermore, Vₚₙ and the on-resistance of NMOS FET 402 are less than the corresponding parameters of Q1.

Approximately, the operation of the circuit of FIG. 5 is as follows. For V_{TBU}<Vₚ₁, transistors Q1-Q4 are all conducting, and a first trigger current Iₜ₁=Vₚₙ/ (Rₒₙ₁||Rₒₙ₂||Rₒₙ₃||Rₒₙ₄). For Vₚ₁<V_{TBU}<Vₚ₂, transistor Q1 is switched off, and the current decreases to a second trigger current Iₜ₂=Vₚₙ/ (Rₒₙ₂||Rₒₙ₃||Rₒₙ₄). Similarly, for Vₚ₂<V_{TBU}<Vₚ₃, transistors Q1 and Q2 are both switched off, and the current further decreases to a third trigger current Iₜ₃=Vₚₙ/ (Rₒₙ₃||Rₒₙ₄) . For Vₚ₃<V_{TBU}<Vₚ₄, transistors Q1-Q3 are switched off, and the current further decreases to a fourth trigger current Iₜ₄=Vₚₙ/Rₒₙ₄. Finally, for V_{TBU}>Vₚ₄, transistors Q1-Q4 are all switched off, and the TBU is in full disconnect mode, where only a leakage current flows. By appropriately selecting the pinchoff voltages Vₚ₁-Vₚ₄ (e.g., such that Vₚ₁Iₜ₁=Vₚ₂Iₜ₂=Vₚ₃Iₜ₃=Vₚ₄Iₜ₄=Pₘₐₓ) , an approximation to a curve of constant TBU power dissipation can be provided, e.g. as shown on FIG. 2. Although four stages are employed in this example, any number of stages can be employed in practicing the invention.

In most cases, it is preferred for the TBU to be implemented as a single integrated circuit. Such implementation of the circuit of FIG. 5 requires fabrication techniques that can provide p-channel devices having different pinch-off voltages on the same die. One approach is to vary the gate width of the p-channel devices, in order to vary the effective depth of the n+ gate region of the p-channel JFETs. Increasing gate width decreases pinch-off voltage and decreasing gate width increases pinch-off voltage, other parameters being equal. Another approach is to use different n+ gate diffusions to provide the various JFET pinch-off voltages.

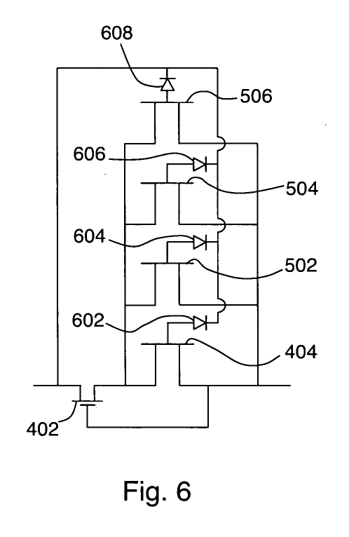

FIG. 6 shows a second example of the invention. The circuit of FIG. 6 is like the circuit of FIG. 5, except that Zener or avalanche diodes 602, 604, 606, and 608 are placed in series with the gates of transistors Q1-Q4. In this example, transistors Q1-Q4 can have identical pinch-off voltages, and diodes 602-608 can be employed to change each transistors effective pinch-off voltage to a distinct value, thereby allowing the circuit of FIG. 6 to operate as described above in connection with FIG. 5. This embodiment allows the use of a simple process flow providing nominally identical p-channel JFET transistors. In the circuit of FIG. 6, it may be useful to connect gate to source in each JFET with a resistor (not shown), typically having a resistance greater than about 100 kΩ, in order to provide diode bias current and prevent charge trapping on the gate. Providing a diode bias current can be helpful for controlling the effective pinch-off voltage more reliably.

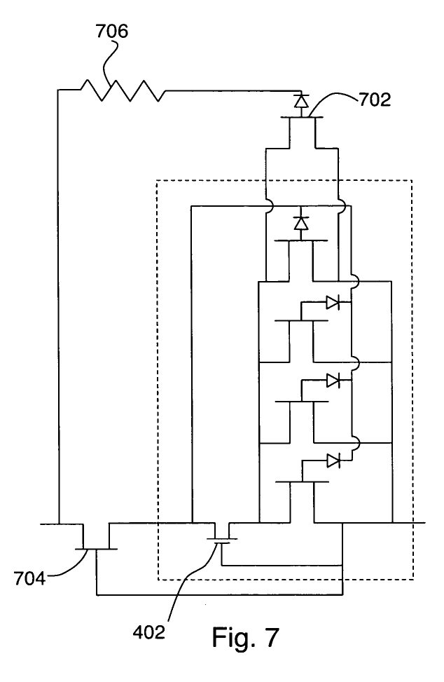

FIG. 7 shows a third example of the invention. The circuit of FIG. 7 is like the circuit of FIG. 6, except that resistor 706 and transistors 702 and 704 are added. The circuit inside the dotted line on FIG. 7 is the circuit of FIG. 6 and can be regarded as a TBU “core”. In some cases, if the TBU core is fully disconnected, the voltage across the TBU core can increase to a level where damage to the TBU core can occur. The circuit of FIG. 7 addresses this issue, since transistors 702 and 704 can switch off in response to excessive TBU core voltage, thereby providing additional voltage handling capability.

In this example, transistor 702 is a p-channel depletion mode JFET having a high (effective) pinch-off voltage. Preferably, the pinch-off voltage of transistor 702 is selected to be the voltage at which minimal leakage current is desired. The high pinch-off voltage of transistor 702 can be provided by direct fabrication of a high Vₚ transistor, or by addition of a series diode to a low Vₚ transistor as described in connection with FIG. 6.

The circuit of FIG. 7 can be regarded as a TBU core within a TBU. In operation, if the TBU core is fully disconnected, but the voltage across the TBU core is not sufficient to switch off transistors 702 and 704, these transistors conduct. Current flow through transistor 702 provides a relatively large leakage current flow, even though the TBU core is fully disconnected. When the TBU core voltage increases to a second disconnect level, transistors 702 and 704 switch off, thereby driving the overall TBU into full disconnect and reducing leakage current flow through the TBU to a minimum. Since transistor 704 can be a high voltage transistor, the overall voltage required to turn off the circuit can be significantly above the voltage handling capability of the TBU core. In this manner, TBU circuits can be made to leak small amounts of current up to very high voltages (e.g., >200 V) without exceeding the TBU power handling capability. This approach can be regarded as providing a final “step” on the I-V curve of FIG. 2 having low current and high voltage. The circuit of FIG. 7 can react very quickly to fast transients (because of the TBU core), while also providing stable high voltage operation and progressive leakage reduction at high voltages.

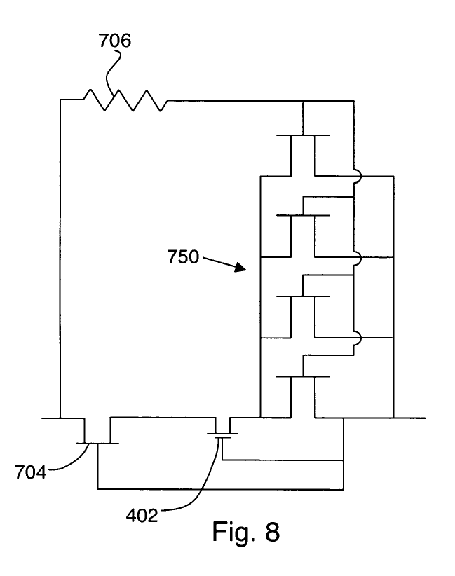

FIG. 8 shows a fourth example of the invention. The circuit of FIG. 8 is like the circuit of FIG. 7, except that the gate diodes on JFET string 750 are omitted (which requires in this configuration that each of the JFETs be manufactured with distinct pinch-off voltages as described above), as is the connection between the gates of JFETs 750 and the source of high voltage FET 704. Like the circuit of FIG. 7, this circuit also provides a high voltage TBU having a partial disconnect capability. At low voltage, the channel of FET 704 is conducting, so the source and drain of FET 704 are effectively at about the same voltage. Therefore, at low voltage the circuit operates as described in connection with FIG. 6, with TBU disconnection controlled by the combination of transistor 402 and JFET string 750. However, for sufficiently high voltages across the circuit, transistor 704 is biased off, thereby providing additional TBU voltage handling capability.

If resistor 706 is not present in the circuit of FIG. 8 (i.e. if it is replaced with a diode, or with a wire to provide a direct connection), the maximum voltage the TBU can block is the gate-drain breakdown voltage of JFET string 750. If resistor 706 is present, then the maximum voltage the TBU can block is the smaller of V1 and V2. Here V1 is the breakdown voltage of high voltage FET 704, and V2=IₐᵥR, where R is the resistance of resistor 706 and Iₐᵥ is the maximum gate to drain avalanche current of JFET string 750. Since V1 and V2 are typically both significantly larger than the gate-drain breakdown voltage of JFET string 750, TBU voltage handling capability is improved by resistor 706. Resistor 706 can also be a current source. Further details of the high voltage approach of FIG. 8 are described in PCT application WO 069753.

The circuits of the preceding examples operate by defining several trigger currents Iₜⱼ and disconnect voltages V_{dj}, selected to ensure that a TBU power dissipation limit Pₘₐₓ is not exceeded (i.e., IₜⱼV_{dj}<Pₘₐₓ for each j). In turn, the power dissipation limit is set such that a TBU temperature maximum Tₘₐₓ is not exceeded, where Tₘₐₓ is selected to be low enough to prevent thermal damage of the TBU in operation. As indicated above, alternative embodiments of the invention employ a temperature sensor to directly control TBU disconnection such that Tₘₐₓ is not exceeded.

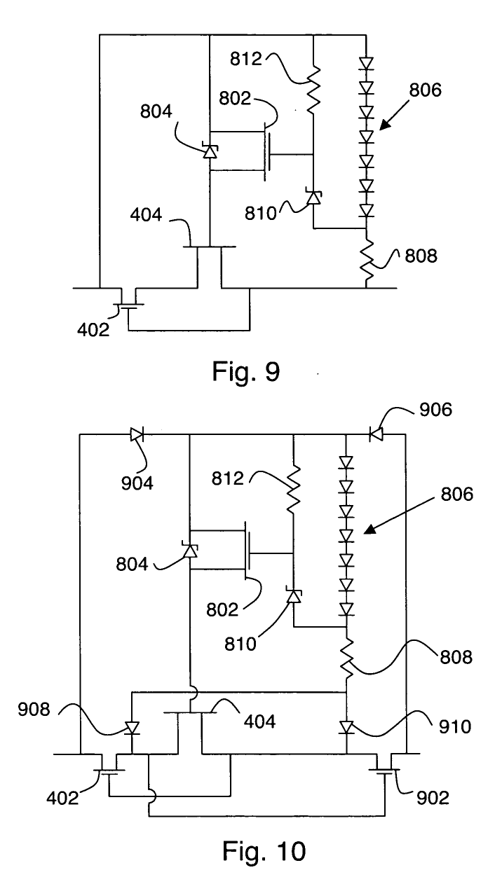

FIG. 9 shows a fifth example of the invention. In this example, temperature is directly monitored. The effective pinch-off voltage of transistor 404 is increased by placing diode 804 in series with its gate. Transistor 802 is placed in parallel with diode 804, and is a normally off device. The circuit of FIG. 9 operates by comparing the voltage across diode string 806 (which is relatively temperature independent) with the voltage across Zener diode 810 (which is highly temperature dependent). With appropriate trimming (i.e., by selecting the values of resistors 808 and 812), the circuit can be made to provide a gate drive to transistor 802 that allows increasing amounts of current to flow parallel to diode 804 as the TBU temperature increases, thereby progressively decreasing the effective pinch-off voltage of transistor 404. In turn, this progressively reduces the TBU trigger current, thereby partially disconnecting the TBU in such a manner as to keep the temperature below Tₘₐₓ. This approach can be regarded as providing a continuous partial TBU disconnection, as opposed to the stepwise disconnection described above. When an absolute disconnection voltage level is reached, the circuit goes into a full disconnect.

In order to obtain such progressive disconnection, diode 804 and shorting transistor 802 are connected to the gate of the TBU transistor having the higher pinch-off voltage. In this example, TBU transistor 404 is thus selected to have a higher pinch-off voltage than transistor 402. If the situation is reversed (i.e., if transistor 404 has a lower pinch-off voltage than transistor 402), the TBU will not act unless the maximum temperature is reached, at which point it will go into a full disconnect (i.e., no partial TBU disconnection occurs in this case). In this case the circuitry effectively provides an electronic PTC (positive temperature coefficient) device for controlling TBU switching, and the resulting TBUs are applicable to high current/high power applications.

The diodes in diode string 806 preferably have a low temperature coefficient in order to provide a stable temperature reference. A preferred approach for providing these diodes is to employ Zener diodes having a breakdown voltage of about 5V, which inherently have low temperature sensitivity.

FIG. 10 shows a sixth example and a preferred embodiment of the invention. This example is a bidirectional TBU based on the circuit of FIG. 9. A second NMOS FET 902 is added to the circuit, as are commutating diodes 904, 906, 908, and 910. For positive current (i.e., flowing from left to right on FIG. 10), transistors 402 and 404 act as a TBU as described above, since diodes 904 and 910 conduct, and diodes 906 and 908 do not conduct. For negative current (i.e., flowing from right to left on FIG. 10), transistors 902 and 404 act as a TBU as described above, since diodes 906 and 908 conduct, and diodes 904 and 910 do not conduct. Similarly, bidirectional TBUs corresponding to the unidirectional TBUs of FIGS. 5-8 are also examples of the invention. Either or both of diodes 904 and 906 can be replaced by functionally equivalent resistors and/or current sources to provide bidirectional TBU operation.

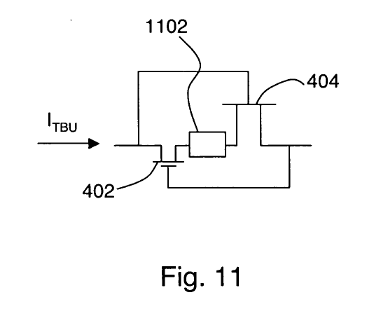

FIG. 11 shows a seventh example of the invention. In this example, a positive temperature coefficient (PTC) device 1102 is disposed in series between the TBU transistors 402 and 404. As the TBU heats up, the resistance of the PTC device increases, thereby decreasing the trip current of the TBU. Preferably, the PTC device resistance increases dramatically at a predetermined threshold temperature (typical PTC threshold temperatures are from about 100° C. to about 140° C.). Suitable PTC devices for practicing the invention are available commercially.

The preceding description is by way of example as opposed to limitation. The invention can also be practiced by making various modifications to these examples. TBUs according to the invention can include any type or polarity of transistor. The pinch-off voltage in the above examples can be regarded more generally as a switching voltage, where input voltages above the switching voltage cause the device to turn off. More generally, the invention is also applicable to other voltage controlled switching elements suitable for making a TBU, such as voltage controlled relays and microelectromechanical (MEMS) switches. The invention is applicable to any kind of uni-directional TBU or bi-directional TBU. Current limiters can be used in place of any or all of the resistors in TBU circuits according to the invention.

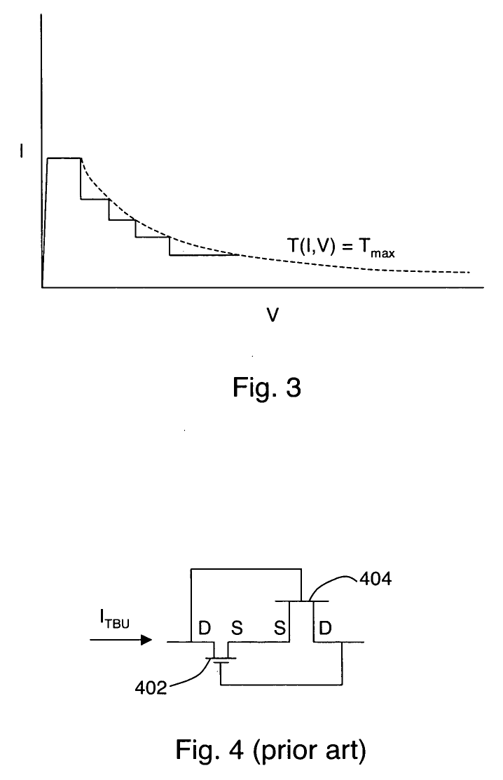

The preceding examples consider cases where partial TBU disconnection is performed in discrete steps to approximate an I-V curve of constant power dissipation and where partial TBU disconnection is performed in a continuous manner to prevent a temperature limit from being exceeded. Principles of the invention should also be applicable to discrete partial TBU disconnection to prevent a temperature limit from being exceeded (e.g., to provide a response as shown on FIG. 3). Similarly, the above principles should also apply to continuous partial TBU disconnection to approximate an I-V curve of constant power dissipation.

1. An apparatus for electrical transient blocking comprising:
a transient blocking unit (TBU) including a first voltage controlled switching element having a first control voltage for controlling current flow between a first pair of terminals, and a second voltage controlled switching element having a second control voltage for controlling current flow between a second pair of terminals;
wherein the first and second voltage controlled switching elements are connected in series such that an above-threshold electrical transient having a first polarity at the TBU alters the first and second control voltages to increase an impedance of the TBU to at least partially block the transient;
wherein the impedance increase is sufficient to ensure a TBU temperature T remains below a predetermined maximum temperature Tₘₐₓ during operation of the TBU.

2. The apparatus of claim 1, wherein a maximum TBU power Pₘₐₓ is derived from said maximum temperature Tₘₐₓ, and wherein said impedance increase is sufficient to ensure a TBU power dissipation P remains below Pₘₐₓ during operation of the TBU.

3. The apparatus of claim 2, wherein said impedance increase is sufficient to substantially block current flow through the transient blocking unit.

4. The apparatus of claim 2, wherein said impedance increase is not sufficient to substantially block current flow through the transient blocking unit.

5. The apparatus of claim 4, wherein said impedance increase is substantially a continuous function of applied voltage to said TBU.

6. The apparatus of claim 4, wherein said TBU has two or more thresholds arranged to provide an I-V curve that is an approximation to an I-V curve of constant TBU power dissipation.

7. The apparatus of claim 6, further comprising one or more additional voltage controlled switching elements, wherein the additional switching elements are disposed in parallel with each other and with either said first switching element or said second switching element to form a switching element array, wherein each element of the switching element array has a different switching voltage, thereby providing said two or more thresholds.

8. The apparatus of claim 1, further comprising a temperature sensor within the transient blocking unit responsive to said TBU temperature, wherein the temperature sensor is employed to control said impedance.

9. The apparatus of claim 8, wherein said impedance increase is sufficient to substantially block current flow through the transient blocking unit.

10. The apparatus of claim 8, wherein said impedance increase is not sufficient to substantially block current flow through the transient blocking unit.

11. The apparatus of claim 10, wherein said TBU has two or more thresholds arranged to provide an I-V curve that is an approximation to an I-V curve of constant TBU temperature.

12. The apparatus of claim 10, wherein said impedance increase is substantially a continuous function of applied voltage to said TBU.

13. The apparatus of claim 12, wherein an effective switching voltage of either said first switching element or of said second switching element is controlled such that the effective switching voltage decreases as TBU temperature increases.

14. The apparatus of claim 8, wherein said temperature sensor comprises a positive temperature coefficient device connected in series between said first and second voltage controlled switching elements.

15. The apparatus of claim 1, wherein the first voltage controlled switching element comprises an n-channel depletion mode field effect transistor and the second voltage controlled switching element comprises a p-channel depletion mode junction field effect transistor.

16. The apparatus of claim 1, wherein the first and second voltage controlled switching elements are selected from the group consisting of voltage controlled relays and micro electro-mechanical switches.

17. The apparatus of claim 1, further comprising a third voltage controlled switching element having a third control voltage for controlling current flow between a third pair or terminals,
wherein the third voltage controlled switching element is connected in series with said first and second voltage controlled switching elements,
wherein an above-threshold electrical transient having a polarity opposite to said first polarity at the TBU alters the second and third control voltages to increase said impedance of the TBU to at least partially block the transient.

18. A method for electrical transient blocking comprising:
providing a transient blocking unit (TBU).including a first voltage controlled switching element having a first control voltage for controlling current flow between a first pair of terminals, and a second voltage controlled switching element having a second control voltage for controlling current flow between a second pair of terminals;
wherein the first and second voltage controlled switching elements are connected in series such that an above-threshold electrical transient having a first polarity at the TBU alters the first and second control voltages to increase an impedance of the TBU to at least partially block the transient;
wherein the impedance increase is sufficient to ensure a TBU temperature T remains below a predetermined maximum temperature Tₘₐₓ during operation of the TBU.
